(19) United States
(12) Patent Application Publication
(10) Pub. No.: US 2017/0174563 A1
(43) Pub. Date: Jun. 22, 2017

(54) Process of producing glass

(71) Applicant: Shuo Lin Hsu, Kaohsiung (TW)

(72) Inventor: Shuo Lin Hsu, Kaohsiung (TW)

(21) Appl. No.: 15/451,435

(22) Filed: Mar. 7, 2017

(51) Int. Cl. C03C 17/00; C03B 23/00

(52) U.S. Cl. CPC C03C 17/001; C03B 23/00; C03C 2217/70; C03C 2218/32

(57) ABSTRACT

A process of producing a glass includes preparing a glass material including silicates; coating a refractory material on the glass material to form a refractory glass material capable of being resistant to 500-1,200° C.; subjecting the refractory glass material to heat to be deformed; shaping the deformed refractory glass material to form a half-finished product having a curved shape by molding; and cooling the half-finished product to produce a finished product. In one embodiment, the refractory material is insulating. In another embodiment, the refractory material is conductive.

### BACKGROUND OF THE INVENTION

1. Field of the Invention

The invention relates to processes of producing glass and more particularly to a process of producing glass having improved surface coating characteristics.

2. Description of Related Art

A conventional process of producing a glass comprises the step of heating a glass for about 24 hours for phase-separation of the glass.

While the process enjoys its success in the market, continuing improvements in the exploitation of processes of producing glass are constantly being sought.

### SUMMARY OF THE INVENTION

It is therefore one object of the invention to provide a process of producing glass comprising preparing a glass material including silicates; coating a refractory material on the glass material to form a refractory glass material capable of being resistant to 500-1,200° C.; subjecting the refractory glass material to heat to be deformed; shaping the deformed refractory glass material to form a half-finished product having a curved shape by molding; and cooling the half-finished product to produce a finished product.

The above and other objects, features and advantages of the invention will become apparent from the following detailed description taken with the accompanying drawings.

### BRIEF DESCRIPTION OF THE DRAWINGS

FIG. 1 is a perspective view of a process of producing glass according to a first preferred embodiment of the invention; and

FIG. 2 is a perspective view of a process of producing glass according to a second preferred embodiment of the invention;

### DETAILED DESCRIPTION OF THE INVENTION

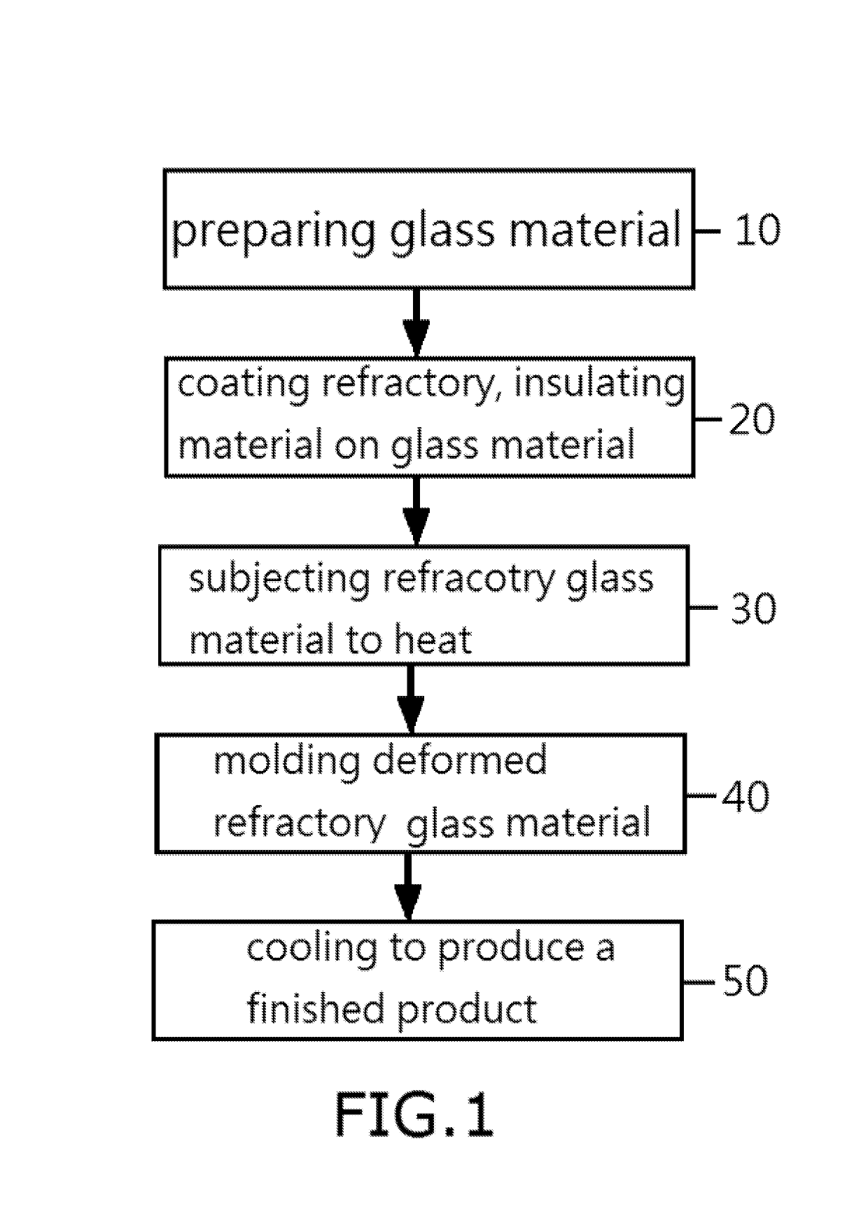

Referring to FIG. 1, a process of producing glass in accordance with a first preferred embodiment of the invention is illustrated. The process comprises steps as discussed in detail below.

Step 10: Glass material including silicates is prepared.

Step 20: A refractory, insulating material is uniformly coated on the glass material to form a refractory glass material capable of being resistant to 500-1,200° C.

Step 30: The refractory glass material is subject to heat to be deformed.

Step 40: The deformed refractory glass material is shaped to form a half-finished product having a curved shape by molding.

Step 50: The half-finished product is cooled to produce a finished product.

Preferably, the refractory, insulating material can be dyed. Further, the finished product maintains the color of the refractory, insulating material.

Preferably, the finished product is used as screen of a mobile phone, screen of a touch panel, etc.

It is envisaged by the invention that no color printing on the half-finished product to form a finished product is required, the finished product has a desired color, and the finished product is not liable to fading.

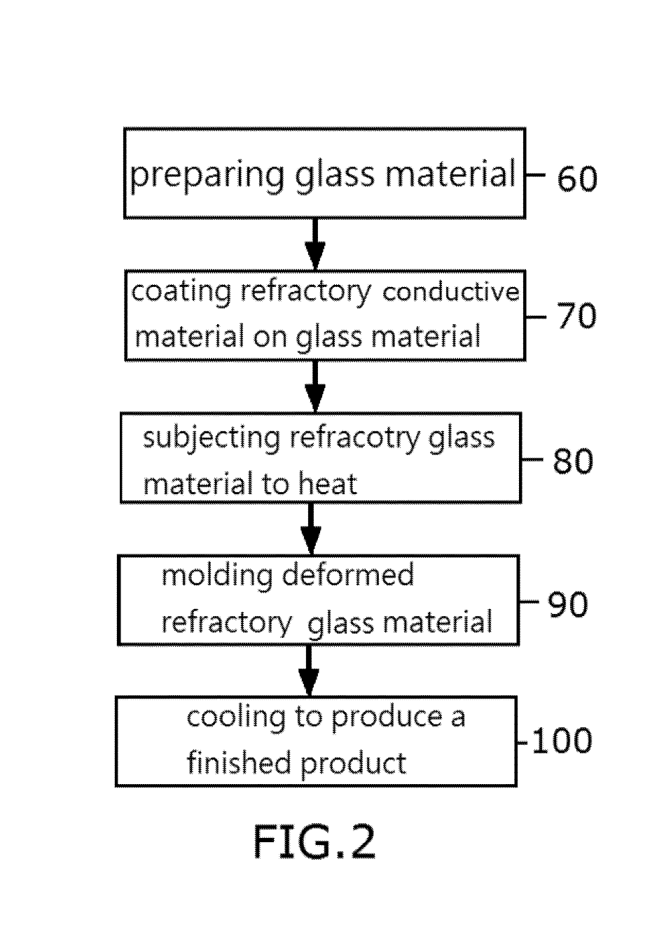

Referring to FIG. 2, a process of producing glass in accordance with a second preferred embodiment of the invention is illustrated. The process comprises steps as discussed in detail below.

Step 60: Glass material including silicates is prepared.

Step 70: A refractory, conductive material is uniformly coated on the glass material to form a refractory glass material capable of being resistant to 500-1,200° C.

Step 80: The refractory glass material is subject to heat to be deformed.

Step 90: The deformed refractory glass material is shaped to form a half-finished product having a curved shape by molding.

Step 1000: The half-finished product is cooled to produce a finished product.

While the invention has been described in terms of preferred embodiments, those skilled in the art will recognize that the invention can be practiced with modifications within the spirit and scope of the appended claims.

What is claimed is:

1. A process of producing a glass comprising:
preparing a glass material including silicates;
coating a refractory material on the glass material to form a refractory glass material capable of being resistant to 500-1,200° C.;
subjecting the refractory glass material to heat to be deformed;
shaping the deformed refractory glass material to form a half-finished product having a curved shape by molding; and
cooling the half-finished product to produce a finished product.

2. The process of producing a glass of claim 1, wherein the refractory material is insulating.

3. The process of producing a glass of claim 1, wherein the refractory material is conductive.
